(19) United States
(12) Patent Application Publication
(10) Pub. No.: US 2010/0094838 A1
(43) Pub. Date: Apr. 15, 2010

(54) Compatibility Server for Database Rehosting

(75) Inventor: Joseph Kozak, Alpharetta, GA (US)

Correspondence Address: FOX ROTHSCHILD, LLP;Pittsburgh, 997 Lenox Drive, Bldg. #3, Lawrenceville, NJ, 08648, US

(73) Assignee: ANTs Software Inc., Burlingame, CA (US)

(21) Appl. No.: 12/259,210

(22) Filed: Oct. 27, 2008

Related U.S. Application Data
(60) Provisional application No. 61/104,392, filed on Oct. 10, 2008.

(51) Int. Cl. G06F 17/30

(52) U.S. Cl. 707/705; 707/E17.055

(57) ABSTRACT

A system and method describing a compatibility server for rehosting database applications written for a specific vendor's database on the database of a second vendor, without the need of rewriting the application to take into account differences in the application programming interfaces between the first vendor's database and the second vendor's database. Requests for access to the database are translated from one format to another at execution time. The server is also capable of translating error messages, data types and data formatting from the format used by the second database to that expected when making requests to the first database. Stored procedures defined in the first database are migrated to the second database as text blocks, and are translated at execution time into a high level programming language, compiled and executed against the second database. All information necessary for the mapping of schema, data, data types, error and status messages and data formatting, as well as information necessary to execute stored procedures, is stored in a plurality of metadata tables in the second database, which are created during a migration phase prior to executing the application.

### RELATED APPLICATIONS

The application claims the benefit of U.S. Provisional Patent Application Ser. No. 61/104,392, filed Oct. 10, 2008 and entitled “Database Compatibility Server”, which is incorporated herein in its entirety.

### BACKGROUND OF THE INVENTION

Most large companies are dependent upon several database applications and their related databases for their day to day operation, for example, for payroll, inventory, accounts payable and receivable and for other specialized purposes. While some of these applications are off the shelf, many have been custom designed to meet the specific needs of each particular company. Typically, critical applications are built for a specific vendor's database, and are incompatible with databases from other vendors. Thus, databases and their applications represent a very high cost for companies when licensing fees, support personnel and ongoing maintenance costs are taken into account.

If applications can be consolidated to utilized only one vendor's database, a significant cost saving can be realized. Applications utilizing databases from a common vendor tend to reduce licensing fees and support personnel costs. Therefore, it would be desirable to choose a database from a particular vendor and to migrate applications to that database.

Migrating an application from one database to another requires two major steps: database migration and application migration. Database migration involves migrating the data resident in the databases to the target database. Database migration can often accomplished by utilization of an automated tool. As an example, Oracle, a major database vendor, has a tool called the Oracle Migration Work Bench (OMWB), that converts the data, schema and some stored procedures (procedures resident in the database) to the new target database. However, one drawback with such tools is that their ability to convert stored procedures to the target database is limited.

Application migration is the modification of the code of an application to use the target database instead of the application's native database, for example, by changing the code to utilize the API of the target database instead of the API of the application's native database. This is typically a difficult, costly and time-consuming manual effort and is one of the major roadblocks to database consolidation.

Therefore, it would be desirable to provide a way to run database application on databases other than the native databases for which they were written, but without the costly and lengthy migration procedure. It would also be desirable to provide a way to migrate stored procedures from a native database to a target database without the necessity of rewriting the stored procedure in the target database dialect.

### SUMMARY OF THE INVENTION

In this document, the terms “native application” and “native database” shall refer to an application written for a specific database, while the term “target database” shall refer to the specific database to which the application is being migrated.

The present invention meets the objectives of migrating database applications from their native database to a target database with little or no re-writing. In addition, it also fulfills the objective of being able to utilize stored procedures from the native database with the target database. This provides complete transparency to the original application, which has no knowledge that it is being run on a database other than the native database for which it was written. The invention was originally conceived for utilization for transfers from relational native databases to relational target databases, but it could also be used for conversions to and from relational and other types of databases, such as object oriented databases.

The invention consists of two parts, a migration component and an execution component. The migration component is run once as the conversion from the native database to the target database takes place. He purpose of the migration component is to convert the database schema, data and stored procedures (and their triggers) from the native database to the target database. In addition, other information may also be transferred, such as user identifications and authentication information and privilege information. The migration component will also create metadata that provides mapping and other information necessary to locate and utilize the data and stored procedures once they are transferred to the target database. The metadata may be stored in any convenient location and in any convenient form, for example, in tables defined in the target database, in a flat file, or in a third database.

Note that some vendors may provide tools that perform portions of the functionality of the migration component. The aforementioned Oracle Migration Work Bench, for instance provides for the reliable transfer of data from other databases to the Oracle database, but is unable to provide reliable transfer of stored procedures. Therefore, in an implementation of the invention for which the Oracle database is the target, the data transfer functionality may not be included as part of the invention.

The execution component of the invention is “middleware” which sits between the native application and the target database, and provides run-time support for rehosting the native application with the target database. During execution, the native application is able to operate as if it were still communicating with the original native database, while the target database operates as if it were communicating with an application written specifically for the target database. Therefore, two-way transparency is provided, from the application to the database and from the database to the application.

The execution component intercepts database queries from the native application and translates them to a dialect understood by the target database. The translated queries are then executed against the target database. When the results are received from the database they are formatted as though they originated from the native database and returned to the native application. To assist in the translation of the query to the dialect of the target database, the execution component is able to access and understand the metadata tables that were created as part of the migration process. The execution component is also able to handle conversions between incompatible data types in the native database and the target database, and is able to translate error and status messages received from the target database such that they can be understood by the native application.

The automatic translation of stored procedures from the native database to the target database may be unreliable because of differences between the functionality and interfaces of the native and target databases. Therefore, the present invention handles these in another way. During the migration phase, procedures stored in the native database are stored in a metadata table in the target database without translation.

When it becomes necessary to execute one of these stored procedures, the procedure is retrieved from the target database, translated into a program written in a computer language, such as “C”, compiled and executed against the target database. The compiled procedure is kept in that form for the life of the instance of the database.

The compatibility server provides the means for an application written for one database to operate with another database. In implementation, it will be necessary to have different versions of the invention for each type of rehosting scenario. The details of the invention are set forth below.

### BRIEF DESCRIPTION OF THE DRAWINGS

FIG. 1 is a schematic drawing showing the process for migrating from a native database to a target database.

FIG. 2 is a schematic drawing showing the configuration of the client, server and middleware at execution time.

FIG. 3 is a schematic showing one possible architecture for the compatibility server of the present invention.

### DETAILED DESCRIPTION

A exemplary implementation of the present invention is presented herein. It will be realized by one of skill in the art that many implementations exist that will yield the same functional results. Therefore the particular architecture shown is not meant to be limiting. Functionality may be provided by different software components or different organizations of software components than those shown without deviating from the scope of the invention.

The typical hardware setup consists of a computer, typically a personal computer or equivalent, executing a database application. The database may be running on the same machine as the database application or may be on a different machine connected to the machine running the application via any known means of communications, but typically via a local area or wide area network. The compatibility server may be executing on the same computer on which the application is running, on the computer on which the database is executing, or on a separate machine, and may communicate with the other computers over a local area or wide area network.

### Migration Process

Before the intended target database can be used by the native application, a migration process must be performed. The migration process consists of migrating the current database schema, data, triggers and stored procedures to the target database and is handled by the migration component of the invention. Note that the term “target database” may not refer to a solitary database, but may consist of several databases, as well as support files in formats other than a database file. Likewise “native database” refers to the database or databases used by the native database application, regardless of their physical or logical configuration.

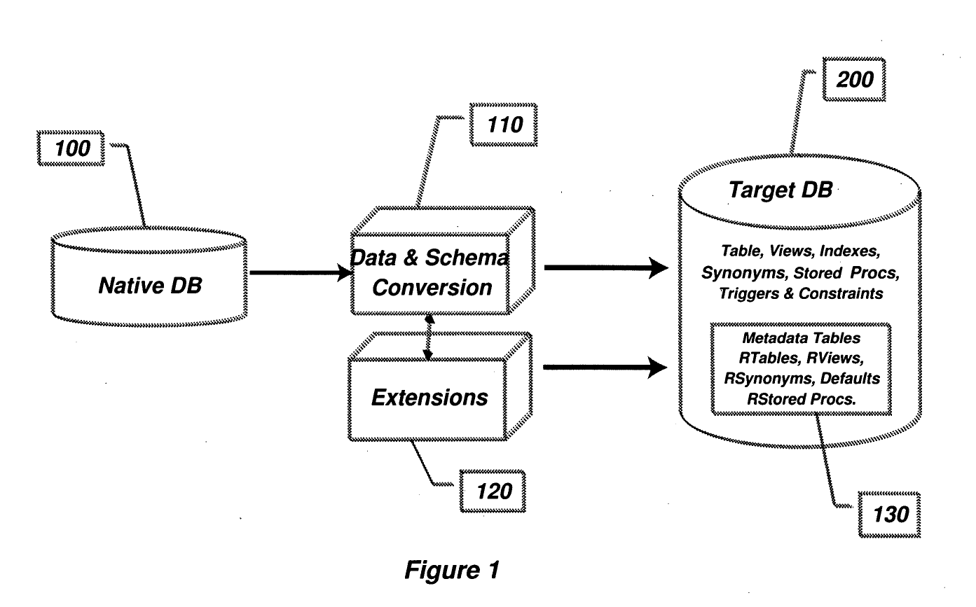

FIG. 1 shows a schematic view of the migration process. Native database 100 is read and analyzed by the migration component, which consists of data and schema conversion portion 110 and extension portion 120.

The data and schema are migrated from native database 100 to target database 200. Due to the likely differences in the structure of the database files and the data types defined by each database, a one to one mapping of data and schema between the native database and the target database may not be possible. During the migration process, all objects contained in native database 100 are mapped and copied to target database 200 and any incompatibilities between the structures and capabilities of native database 100 and target database 200 are resolved by entries made in metadata tables 130. For instance, target database 200 may not define the same data types as native database 100. In such a case, the conversion portion 110 and extension portion 120 would map one data type in native database 100 to a different data type in target database 200, and that mapping would be preserved as metadata. In addition, stored procedures and any triggers for stored procedures are also migrated to target database 200.

Stored procedures are migrated to target database 200 in one of two ways. If the dialect of target database 200 supports the same types of calls used in native database 100, the stored procedure may be converted to the dialect of target database 200 and stored as a stored procedure in whatever form is used by target database 200.

However, if the dialect of target database 200 is sufficiently different from that of native database 100, the stored procedure is stored in target database 200 in its native dialect, preferably as a text block. In such cases, the conversion of the stored procedure happens at execution time, in the manner described below. In such cases, data entries may be made in metadata tables 130 to support the interpretation and running of the stored procedure. The metadata tables provide information to compatibility server 300 to provide a mapping from the old procedures to the new procedures, and to let compatibility server 300 know whether or not the procedure must be compiled before being executed or whether it may be executed directly out of target database 200.

Extension portion 120 of the migration component is responsible for setting up metadata tables 130. As discussed, metadata tables 130 contain information about the structure of the native database 100 as well as the structure of the target database 200 and how the two are mapped together. Preferably, metadata tables will be stored in target database 20, however, in implementation, the metadata may be stored in any location convenient to compatibility server 300.

In addition, metadata tables 130 may contain information about the users and privileges associated with various users of the native database 100. Compatibility server 300 will follow the rules and privileges for access to the target database which were set up in the native base 100.

Note that several well known database vendors provide data conversion tools to convert from native database 100 to a target database 200. In such cases, those tools may be utilized and become part of the migration component. However, it will still be necessary to migrate the stored procedures from native database 100 to target database 200 in their native format and to create metadata table entries regarding those procedures.

Once the complete contents of native database 100 are migrated to the target database 100 the execution of the native applications may proceed.

### Execution Component

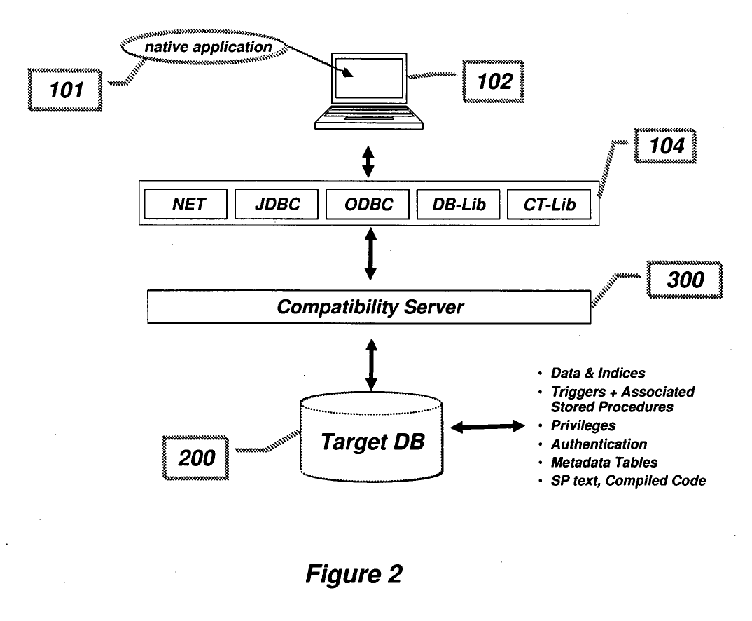

FIG. 2 is a schematic showing the system at execution time. Native application 101 on client computer 102 is communicating with compatibility server 300 through an API 104. The particular API which is used (several commonly available API's are shown in box 104) is dependent upon the language in which the native application is written. Most vendors databases have APIs for various languages. For example, .net is the API for Microsoft's .net language while JBDC is the API for Java based applications.

API 104 communicates with compatibility server 300 via any method known in the art, such as through process to process communication (if the two are running ion the same system) or over a LAN or WAN. Compatibility server 300 may be running on the machine 102 on which native application 101 is running, on the machine on which target database 200 is executing, or on a third machine. The physical and logical arrangement of native application 101, API 104 and compatibility server 300 is not an important aspect of this invention. As will be realized by one of skill in the art, many configurations of these components are possible, and the invention is meant to include all physical and logical configurations.

API 104 passes requests from native application 101 to compatibility server 300 over a communication link, possibly a network link. Compatibility server 300 is responsible for receiving the request from native application 101, which may be a request for a data storage, retrieval or manipulation for native database 100. Compatibility server 300 then translates that request into one that can be understood by target database 200 and executes the request against target database 200.

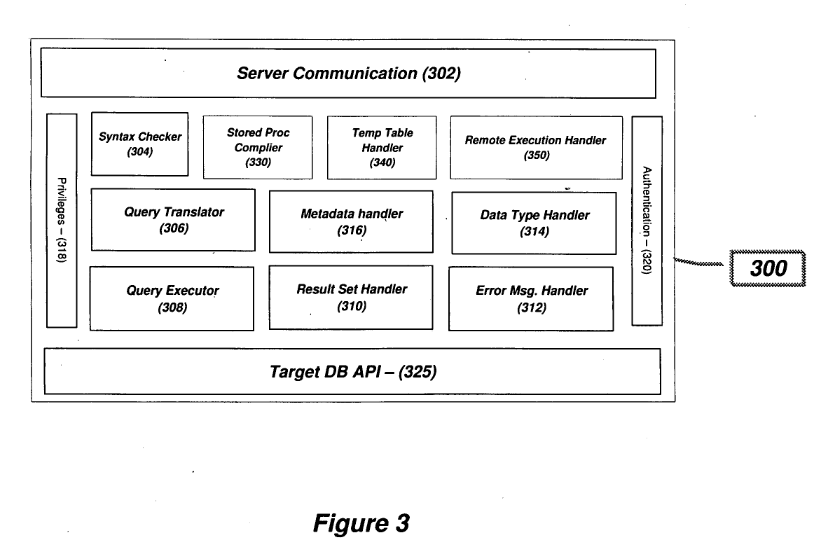

FIG. 3 shows one possible logical arrangement of the internal structure of compatibility server 300, broken down into functional components. Server communication component 302 provides a communication link to the particular API 104 being utilized by native application 101. Server communication component 302 is responsible for receiving requests through API driver 104 and for returning results, status and error messages from target database 200 back through API 104 to native application 101. As previously stated, communications between server communications component 302 and API 104 may be through inter-process communication channels (if they are running on the same physical machine) or via a local area or wide area network link.

When a requests comes in from a specific user, the user is first authenticated by authentication component 320. Authentication component 320 must have knowledge of the users and their passwords that were defined in native database 100. This information is stored in metadata tables 130. Thus, the users that are defined for the target database 200 are not used for the purpose of authenticating end users.

Once the user has been authenticated, the user's privileges must be assessed by privileges component 318. A particular user may not be able to access all schemas, tables or views within target database 200. Therefore, privileges component 318 checks to see whether the user has the required privileges for the operation he is asking to perform.

Component 304 is the syntax checker for DML (data manipulation language) and DDL (data definition language). Syntax checker 304 verifies the syntax of SQL and other requests received from native application 101 to ensure compliance with the dialect of native database 100. If a valid request with correct syntax is detected by syntax checker 304, the request is passed to query translator 306. If the request is not properly formatted for the dialect of native database 100, an error message is returned to native application 101.

Query translator 306 is responsible for translating the received query from the dialect of native database 100 to the dialect of target database 200. Query translator 306 not only handles queries (requests for data), but also handles requests of all types, such as requests for the storage of data, requests for manipulation of data within the database, and informational requests. Therefore, the word “query” as used herein is meant to include all types of commands to the database. To complete the translation, query translator 306 may require information stored in metadata tables 130, in which case metadata handler 316 would be called to retrieve and interpret the metadata.

Once the translation is completed, the query is passed to query executor 308. Query executor 308 is responsible for executing the query against target database 200. Query executor 308 accesses target database 200 through target database API 325, which is a low level application programming interface for target database 200. This component is typically provided by the vendor of the database being used as target database 200.

If syntax checker 304 receives a request to execute a stored procedure, one of two things happen. First, syntax checker 304 has no knowledge of whether the stored procedure is stored in the dialect of the target database 200 or is stored as text in the language of the native database 100. Therefore, syntax checker 304 will consult the metadata tables 130 using metadata handler 316 to determine how to handle the request. If the procedure is stored in target database 200 in the dialect of target database, and is directly executable from target database 200, then syntax checker 304 will pass the request to query translator 306 as though it were any other type of query.

However, if the procedure is stored in target database 200 in the format of the native database 100 as a large block of text, then the query is passed to stored procedure compiler 330 for interpretation, emulation or translation.

In the preferred embodiment of the invention, stored procedure compiler 330 will read the stored procedure in the form of a text block from target database 200 and will convert it to a program written in a high level computer language, such as C. The program is then compiled as an executable against target database 200 and it is executed through target database API 325. Because there is no translation, the compiled program is executed directly through the target database API 325.

Procedures from native database 100 are stored as large blocks of text in cases where there may not be a one to one correspondence between the dialect of native database 100 and target database 200. For example, native database 100 may have a request type that returns data in a sorted form, but target database 200 may only be able to request data in the form in unsorted form. The program generated by stored procedure complier 330 will resolve these differences.

Many ways of handling stored procedures are possible, as the stored procedures may be stored in the dialect of native database 100, in the dialect of native database 200, or in some interim form, such as in a high level language or as an executable. The conversion of the stored procedure may happen at migration time or at execution time. Stored procedure compiler 330 is responsible for retrieving the stored procedure, in whatever form (with the assistance of metadata tables 130) and executing the stored procedure against target database 200.

Note that stored procedure may not only be executed as the result of a request from native application 101, but may be executed automatically as the result of some other action in target database, as defined one or more triggers. Stored procedure compiler 300 is responsible for executing the stored procedure in this case as well, and, in some cases, may also be responsible for checking if certain conditions for triggers have been met, if target database 200 is not capable of doing so.

Results set handler 310 receives data from target database 200 through target database API 325 and formats the data to make it seem as though it were coming from native database 100 before it is returned to native application 101. Different databases return data differently—for example, some databases may stream data in a large buffer while other databases may use a cursor method where each new record is received only after an additional request from the application.

Target database API 325 will pass the result set to query executor 308. Query executor 308 may then pass the result set to result set handler 310 for reformatting.

The knowledge of whether or not the result set needs to be processed by result set handler 310 is resident in metadata tables 130. Therefore, query executor 308 may have need to consult metadata table handler 316 at this time. Note that results set handler 310 may utilize memory buffers or temporary tables in target database 200 or elsewhere to reformat the result set.

Data type handler 314 is responsible for mapping between incompatible data types defined in target database 200 and native database 100. Because native database 100 and target database 200 are likely produced by different vendors, it is probable that at least some of the data types defined for native database 100 will not be present in target database 200, and vice versa. Data type handler 314 has knowledge of how data is mapped from one data type to another in the database in this situation, and is responsible for making the correct conversion. The knowledge of the difference between data types defined for native database 100 and data types defined for target database 200 is stored in metadata tables 130. Therefore, data type handler 314 may consult metadata tables 130 through metadata handler 316.

Error message handler 312 is responsible for resolving differences between status and error messages received from target database API 325 in the format defined by target database 200 to the format defined by native database 100. This component is typically called from query executor 308 after query executor 308 receives a response from target database 200 through target database API 325. The knowledge of the mappings between error and status messages defined by target database 200 and native database 100 is resident in metadata tables 130. Therefore, it may be necessary for error message handler 342 to consult these tables through metadata table handler 316.

Temporary table handler 340 is responsible for resolving differences in the way temporary tables are handled by native database 100 and target database 200. For example, temporary table handler 340 may receive result sets from result set handler 310 and may store those temporarily in tables in target database 200 as interim results. Temporary table handler 340 ensures that temporary tables are handled by target database 200 in a manner identical to how native database 100 handles temporary tables.

Remote execution handler 350 is responsible for handling requests for tables, SPTs (stored procedures and triggers) and functions for target databases that are remotely located. Remotely located databases can be another instance of target database 200 operating on the same system, another database file resident on the same system or may be a database on another physical machine which is accessible over a network. Requests for remote databases are routed through component 350 and are received and processed by the corresponding component in another instance of compatibility server 300 operating in tandem with remotely located databases. Remote execution handler 350 also receives requests from other instances of compatibility server 300 from remote machines for local target databases and processes them accordingly.

The system described herein is exemplary in nature and is not meant to be limiting. The intended scope of the invention is expressed in the following claims.

I claim:

1. A system for allowing an application written for a first database from a first vendor to be used with a second database from a second vendor comprising a compatibility server for emulating said second database when requests are received from an application written for said first database.

2. The system of claim 1 comprising:
a. a request translator, for translating requests in the dialect of said first database to the dialect of said second database; and
b. a request executor, for executing said translated requests against said second database.

3. The system of claim 2 further comprising a message handler; for translating error and status messages received from said second database to those used by said first database.

4. The system of claim 1 further comprising a store of metadata describing mappings of objects and structure between said first database and said second database.

5. The system of claim 4 wherein said store of metadata is resident in one or more tables in said second database.

6. The system of claim 4 wherein said store of metadata is resident external to said second database

7. The system of claim 4 further comprising a metadata handler for reading and interpreting said metadata.

8. The system of claim 4 wherein said second database contains procedures copied from said first database.

9. The system of claim 8 wherein said procedures are stored in said second database as one of a group consisting of a procedure in the dialect of said second database, a procedure in an interim form and a text block containing the procedure in the dialect of said first database.

10. The system of claim 8 further comprising a stored procedure handler for interpreting, emulating or translating said procedures for execution against said second database.

11. The system of claim 8 wherein procedures stored as text blocks in said second database are translated into a high level programming language, compiled, and executed against said second database.

12. The system of claim 11 wherein said translation of said procedure occurs at execution time.

13. The system of claim 4 further comprising a component for formatting the results of queries from said second database to a format expected from said first database.

14. The system of claim 4 further comprising a data type handler for translating from data types used by said first database to data types used by said second database.

15. The system of claim 2 further comprising a component for interfacing with other instances of said system for accessing remotely located databases.

16. The system of claim 4 further comprising a migration component for analyzing differences between said first database and said second database, for creating said metadata store, and for reading procedures stored in said first database and storing said procedures in said second database.

17. The system of claim 16 wherein said migration component copies schema and data from said first database to said second database.

18. The system of claim 4 further comprising a privilege and authentication checker, for verifying the rights of users with respect to requests for access to said first database.

19. The system of claim 18 wherein information regarding the authentication and privileges of said users is stored in said metadata store.

20. A method for allowing an application written for a first database from a first vendor to be used with a second database from a second vendor comprising the step of providing an interface to said second database which caused said second database to emulate said first database

21. The method of claim 20 further comprising the steps of:
a. receiving requests for data queries, data storage and database manipulation from an application running on a computer, said requests being in a format required by said first database;
b. translating said received requests into a format required by said second database;
c. executing said translated request against said second database;
d. formatting results received from said first database in response to said request to a form expected from a request to said first database.

22. The method of claim 20 wherein said formatting results step further comprises the steps of:
a. mapping from data types defined by said second database to data types defined by said first database;
b. formatting received data to a form expected from a request to said first database;
c. mapping error and status messages received from said second database to a form expected from said first database.

23. The method of claim 22 further comprising the step of:
a. reading metadata from metadata stores, said metadata containing information about the mappings of data types from said second database to said first database, information about formatting data received from said second database to a form expected from said first database and information regarding the mapping of said error and status messages from said second database in a form expected from said first database; and
b. using said metadata to complete said formatting step.

24. The method of claim 23 wherein said metadata contains information necessary for the execution of stored procedures, further comprising the step of reading said metadata regarding said stored procedures when a request for execution of a stored procedure is received.

25. The method of claim 24 wherein said metadata regarding stored procedures includes information regarding whether said stored procedures are stored in the format of said second database or are stored in an interim form.

26. The method of claim 25 further comprising the steps of:
a. determining if said stored procedure is stored as a text block in the source language of said first database, and if so, continuing;
b. reading said stored procedure as a text block;
c. translating said stored procedure into a known computer language, including calls to an API for said second database;
d. compiling said translated stored procedure into an executable; and
e. executing said stored procedure against said second database.

27. The method of claim 21 further comprising the step of checking the syntax of said received requests to ensure that they comply with the request format required by said first database.

28. The method of claim 23 further comprising the step of checking the authentication and privileges of users making said requests.

29. The method of claim 28 further comprising the step of retrieving information regarding the privileges and authentication of said users from said metadata stores.

30. A compatibility server for allowing an application running on a client written for a first database from a first vendor to be used with a second database from a second vendor comprising:
a. a communications component, for handling communications between said application running on said client and said compatibility server;
b. a syntax checker, for verifying that requests for database access received from said application are in the dialect of said first database;
c. a request translator, for translating requests in the dialect of said first database to the dialect of said second database;
d. a request executor, for executing said translated requests against said second database;
e. a message handler; for translating error and status messages received from said second database to those used by said first database;
f. a result set handler, for formatting the results of queries from said second database to a format expected from said first database;
g. a data type handler for translating from data types used by said second database to data types used by said first database;
h. a privilege and authentication checker, for verifying the rights of users with respect to said requests; and
i. a metadata handler for reading and interpreting metadata, said metadata describing mappings between said first database and said second database, said mappings including information regarding objects selected from a group comprising users, schema, data, data types, triggers, stored procedures, error and status messages and result set formats.

31. The compatibility server of claim 30 wherein said second database contains procedures stored as text blocks copied from said first database, further comprising a stored procedure handler for translating said procedures stored as text blocks into a programming language, compiling said translated procedure and executing said compiled procedure against said second database.

32. The compatibility server of claim 30 further comprising a component for interfacing with other instances of said compatibility server for accessing remotely located databases.
